(19) United States
(12) Patent Application Publication
(10) Pub. No.: US 2015/0379023 A1
(43) Pub. Date: Dec. 31, 2015

(54) METHOD AND SYSTEM FOR EMBEDDING AN ENRICHMENT APPLICATION FILE INTO A HOST APPLICATION FILE

(71) Applicant: OUTMOBILE LTD., Ramat Gan (IL)

(72) Inventors: Ofir SHABTAY, Ramat Gan (IL); Marc Steinitz, Ramat Gan (IL); Yuval Ben Haroch, Ramat Gan (IL)

(21) Appl. No.: 14/318,780

(22) Filed: Jun. 30, 2014

(51) Int. Cl. G06F 17/30

(52) U.S. Cl. CPC G06F 17/30076; G06F 17/30115

(57) ABSTRACT

A method for embedding an enrichment application file into a host application file may include: decompiling the enrichment application file and the target application file, to yield data files and intermediate language files; copying layout files from the enrichment application file, to folders of the decompiled host application file; merging the data files of the decompiled enrichment application file, with values folders of said host application file; changing application permissions file of the host decompiled application file; scanning all intermediate language files and mapping at least one of: activities and screens; and compiling the merged files back to an application file format, to yield an enriched host application file.

### FIELD OF THE INVENTION

The present invention relates generally to merging software applications, and more specifically to such merging of user equipment applications.

### BACKGROUND OF THE INVENTION

Prior to the background of the invention being set forth herein, it may be helpful to set forth definitions of certain terms that will be used hereinafter.

The term “enriching application” or as used herein is defined as an application that enables taking over of another application, monitor its flow and user interface and adjust parameters and also add activities that were not present in the original application.

The term “resource” as used herein is defined in the context of java and other programming languages as a piece of data that can be accessed by the code of an application. An application can access its resources through uniform resource locators.

Many software applications which tailored for user equipment (UE), such as smart telephones, tablet PC, and the like, may serve as a platform for advertisements and other publishing purpose in a manner similar to publishing on the Internet. Unlike the Web, adding content and functionalities to UE application files, such as APKs, IPAs, XAPs, and the like, is more challenging.

### SUMMARY OF THE INVENTION

Some embodiments of the present invention disclose a system and a method for embedding an enrichment application file into a host application file is provided herein. The method may include the following steps: decompiling the enrichment application file and the target application file, to yield data files and intermediate language files; copying layout files from the enrichment application file, to folders of the decompiled host application file; merging the data files of the decompiled enrichment application file, with values folders of said host application file; changing an application permission file of the host decompiled application file; scanning all intermediate language files and mapping at least one of: activities and screens; and compiling the merged files back to an application file format, to yield an enriched host application file.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be more fully understood by reference to the following detailed description when read with the accompanying drawings in which:

FIGS. 1A and 1B are block diagrams illustrating an operational environment in accordance with the present invention;

FIGS. 2A and 2B are graph diagram illustrating an aspect in accordance with some embodiments of the present invention;

FIG. 3 is a block diagram illustrating a system in accordance with some embodiments of the present invention; and

FIG. 4 is a high level flowchart illustrating a method in accordance with some embodiments of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

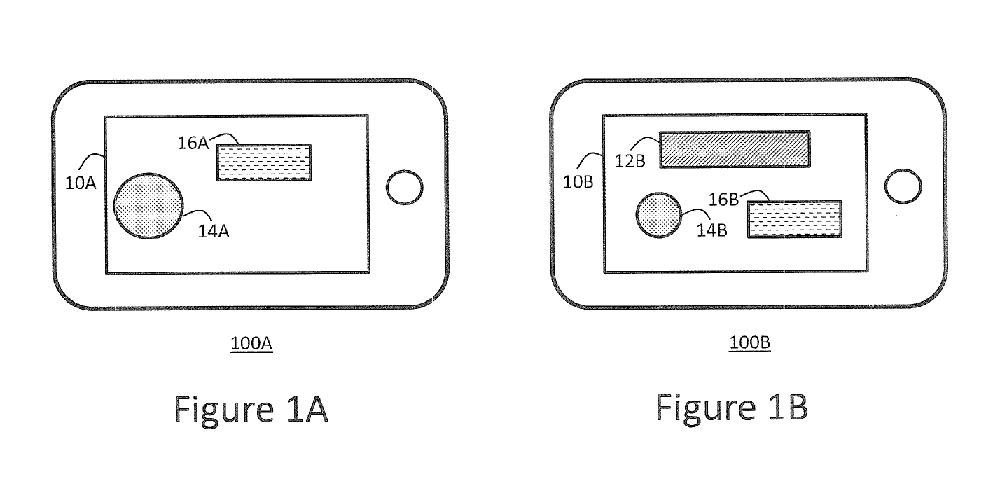

FIG. 1A is a block diagram illustrating an operational environment in accordance with the present invention. Smartphone 100A is shown with a specific screen 10A having an image 16A and a user interface button 14A. Adding an advertisement or other content 12B as shown in FIG. 1B will require a change in the position of image 16B and button 14B may need to become smaller so as to fit in the screen, with the additional content 12B.

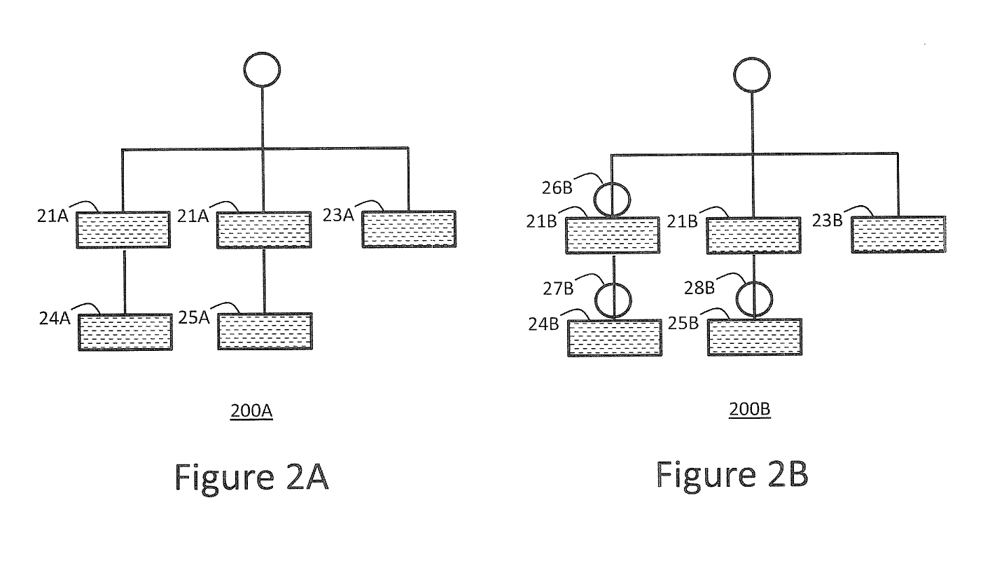

FIGS. 2A and 2B are graph diagrams illustrating an aspect in accordance with some embodiments of the present invention. Graph 200A depicts a regular structure of resources 21A-25A in an application file. FIG. 2B illustrates same code and resources 21B-25B but now with activities 26B, 27B and controls 28B of an enrichment application placed onto important nodes of graph 200B.

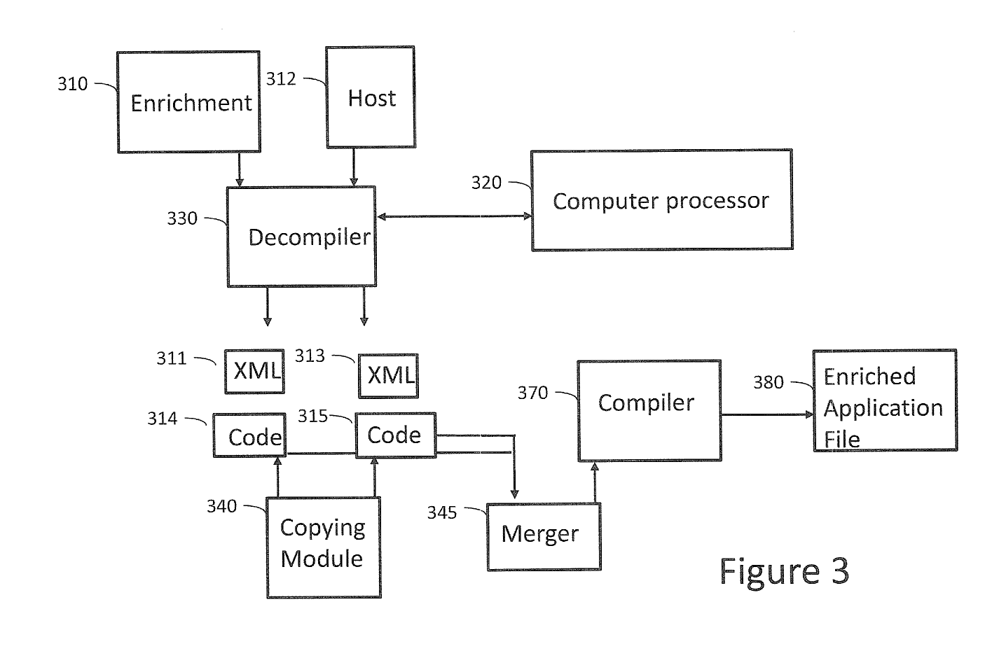

FIG. 3 is a block diagram illustrating a system 300 in accordance with some embodiments of the present invention. System 300 is configured for embedding an enrichment application file 310 into a host application file 312. System 300 may include: a computer processor 320, decompiler 330 configured to decompile the enrichment application file 310 and the host application file 312, to yield XML files 311, 313 and intermediate language files 314, 315. System 300 may further include a copying module 340 configured to copy layout files from the enrichment application file, to folders of the decompiled host application file. System 300 may further include a merger 345 configured to merge the XML files of the decompiled enrichment application file, with values folders of said host application file. System 300 may further include a permissions module 350 configured to change an application permissions file (such as manifest.xml file) of the host decompiled application file. System 300 may further include a scanning module 360 configured to scan all intermediate language files and mapping at least one of: activities and screens. System 300 may further include a compiler 370 configured to compile the merged files back to an application file format, to yield an enriched host application file 380.

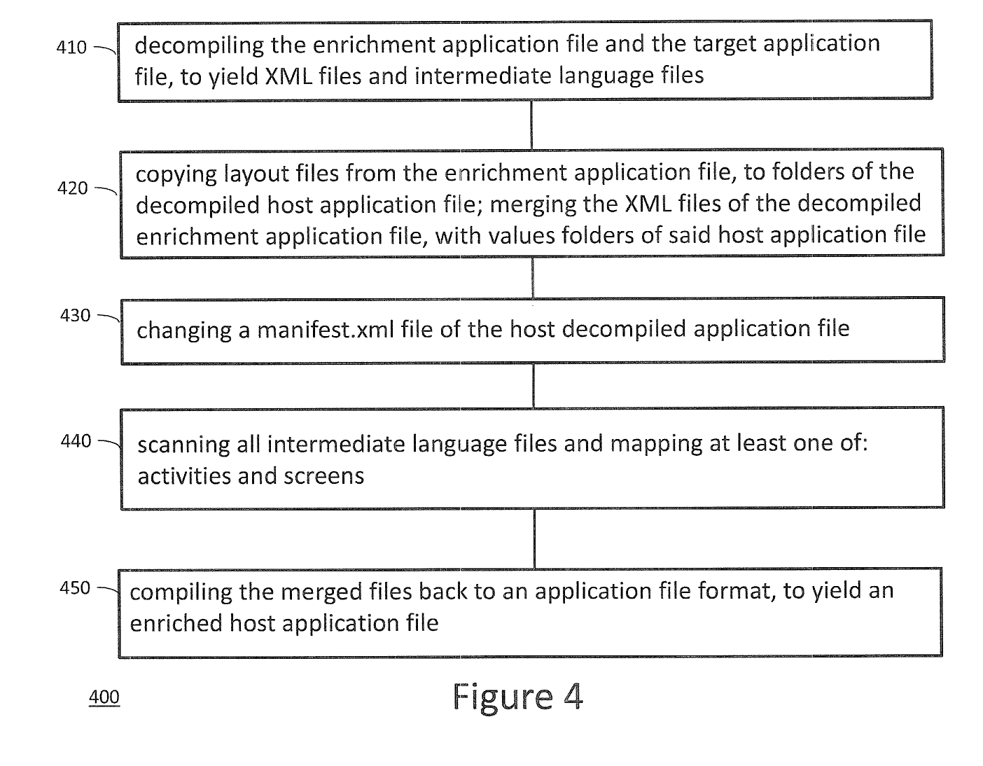

FIG. 4 is a high level flowchart illustrating a method in accordance with some embodiments of the present invention. Method 400 may include the following steps: decompiling the enrichment application file and the target application file, to yield data files such as XML files and intermediate language files 410; copying layout files from the enrichment application file, to folders of the decompiled host application file; merging the XML files of the decompiled enrichment application file, with values folders of said host application file 420; changing an application permissions file of the host decompiled application file 430; scanning all intermediate language files and mapping at least one of: activities and screens 440; and compiling the merged files back to an application file format, to yield an enriched host application file 450.

According to some embodiments of the present invention, the layout files may include non-code files comprising at least one of: static XML files defining the structure, user interface, and images. In other words, resources and their use and architecture within the application.

According to some embodiments of the present invention, the activity defines what a user can do and the screen defines how the user sees said activity.

According to some embodiments of the present invention, further checking said manifest.xml file for certain permissions needed for the enhancing application, and adding said certain permissions in a case the said manifest.xml does not contain said certain permission.

According to some embodiments of the present invention, the scanning and the mapping further comprise adding for each activity whether or not a predetermined content should be added.

According to some embodiments of the present invention, the enriched host application file enables a software owner to selectively alter content or other functionality policy in various user interface scenarios.

According to some embodiments of the present invention, the host values may include at least one of: public.xml, id.xml, style.xml, string.xml without conflicting ids and names.

According to some embodiments of the present invention, the scanning may include analyzing host XML files and in a case that a name of two different files is identical names are changes to avoid conflict.

According to some embodiments of the present invention, the enhanced application may include at least one of: adding new activities, changing styles and themes, changing launch intent, and adding permissions, prior to said compiling the merged files back to an application file format.

According to some embodiments of the present invention, the enhanced application may include resizing all activities screens prior to the compiling the merged files back to an application file format.

According to some embodiments of the present invention, the enhanced application may include adding broadcast receivers to all activities, prior to the compiling the merged files back to an application file format.

According to some embodiments of the present invention, the enhanced application may include handling screen orientation changes in all activities, prior to said compiling the merged files back to an application file format.

According to some embodiments of the present invention, for IOS, the method may include the alternative steps of: decompiling the enrichment application file and the target application file, to yield XML files and assembler files; copying layout files from the enrichment application file, to folders of the decompiled host application file; merging the XML files of the decompiled enrichment application file, with values folders of said host application file; changing a manifest.xml file of the host decompiled application file; scanning all assembler files and mapping at least one of: activities and screens, and compiling the merged files back to an application file format, to yield an enriched host application file.

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” For example, a baseband processor or other processor may be configured to carry out methods of the present invention by for example executing code or software.

The aforementioned flowcharts and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method for embedding an enrichment application file into a host application file, the method comprising:
decompiling the enrichment application file and the target application file, to yield data files and intermediate language files;
copying layout files from the enrichment application file, to folders of the decompiled host application file;
merging the data files of the decompiled enrichment application file, with values folders of said host application file;
changing a application permission file of the host decompiled application file based on permissions required for the enrichment application;
scanning all intermediate language files and mapping at least one of: activities and screens; and
compiling the merged files back to an application file format, to yield an enriched host application file.

2. The method according to claim 1, wherein the data files comprise XML files.

3. The method according to claim 1, wherein the layout files are non-code files comprising at least one of: static XML files defining the structure, user interface, and images.

4. The method according to claim 1, wherein the activity defined what a user can do and the screen defines how the user sees said activity.

5. The method according to claim 1, further checking said manifest.xml file for certain permissions needed for the enhancing application, and adding said certain permissions in a case the said manifest.xml does not contain said certain permission.

6. The method according to claim 1, wherein the scanning and the mapping further comprise adding for each activity whether or not a predetermined content should be added.

7. The method according to claim 1, wherein the enriched host application file enables a software owner to selectively alter content or other functionality policy in various user interface scenarios.

8. The method according to claim 1, wherein the host values comprise at least one of: public.xml, id.xml, style.xml, string.xml without conflicting ids and names.

9. The method according to claim 8, wherein the scanning includes analyzing host XML files and in a case that a name of two different files is identical names are changes to avoid conflict.

10. The method according to claim 1, wherein the enhanced application comprising at least one of: adding new activities, changing styles and themes, changing launch intent, and adding permissions, prior to said compiling the merged files back to an application file format.

11. The method according to claim 1, wherein the enhanced application comprising resizing all activities screens prior to said compiling the merged files back to an application file format.

12. The method according to claim 1, wherein the enhanced application comprising adding broadcast receivers to all activities, prior to said compiling the merged files back to an application file format.

13. The method according to claim 1, wherein the enhanced application comprising handling screen orientation changes in all activities, prior to said compiling the merged files back to an application file format.

14. A method for embedding an enrichment application file into a host application file, the method comprising:
decompiling the enrichment application file and the target application file, to yield data files and assembler files;
copying layout files from the enrichment application file, to folders of the decompiled host application file;
merging the data files of the decompiled enrichment application file, with values folders of said host application file;
changing a manifest.xml file of the host decompiled application file:
scanning all intermediate language files and mapping at least one of: activities and screens, and compiling the merged files back to an application file format, to yield an enriched host application file.

15. A system for embedding an enrichment application file into a host application file, the method comprising:
a computer processor;
decompiler configured to decompile the enrichment application file and the target application file, to yield data files and intermediate language files;
a copying module configure to copy layout files from the enrichment application file, to folders of the decompiled host application file;
a merger configured to merge the data files of the decompiled enrichment application file, with values folders of said host application file;
a manifest module configured to change a manifest.xml file of the host decompiled application file;
a scanning module configured to scan all intermediate language files and mapping at least one of: activities and screens; and
a compiler configured to compile the merged files back to an application file format, to yield an enriched host application file,
wherein the decompiler, the copying module, the merger, the manifest module, the scanning module, and the compiler are executed by said computer processor.

16. The method according to claim 15, wherein the data files comprise XML files.

17. The system according to claim 15, wherein the layout files are non-code files comprise at least one of: static XML files defining the structure, user interface, and images.

18. The system according to claim 15, wherein the activity defined what a user can do and the screen defines how the user sees said activity.

19. The system according to claim 15, further checking said manifest.xml file for certain permissions needed for the enhancing application, and adding said certain permissions in a case the said manifest.xml does not contain said certain permission.

20. The system according to claim 15, wherein the scanning and the mapping further comprise adding for each activity whether or not a predetermined content should be added.

21. The system according to claim 15, wherein the enriched host application file enables a software owner to selectively alter content or other functionality policy in various user interface scenarios.

22. The system according to claim 15, wherein the host values comprise at least one of: public.xml, id.xml, style.xml, string.xml without conflicting ids and names.

23. The system according to claim 22, wherein the scanning includes analyzing host XML files and in a case that a name of two different files is identical names are changes to avoid conflict.

24. The system according to claim 15, wherein the enhanced application comprising at least one of: adding new activities, changing styles and themes, changing launch intent, and adding permissions, prior to said compiling the merged files back to an application file format.

25. The system according to claim 15, wherein the enhanced application comprising resizing all activities screens prior to said compiling the merged files back to an application file format.

26. The system according to claim 15, wherein the enhanced application comprising adding broadcast receivers to all activities, prior to said compiling the merged files back to an application file format.

27. The system according to claim 15, wherein the enhanced application comprising handling screen orientation changes in all activities, prior to said compiling the merged files back to an application file format.
